(19) United States
(12) Patent Application Publication
(10) Pub. No.: US 2011/0119534 A1
(43) Pub. Date: May 19, 2011

(54) METHOD AND APPARATUS FOR PROCESSING PACKETS

(76) Inventors: Lifeng LIU, Chengdu (CN); Dong Zhang, Chengdu (CN)

(21) Appl. No.: 13/012,223

(22) Filed: Jan. 24, 2011

Related U.S. Application Data
(63) Continuation of application No. PCT/CN2009/071733, filed on May 11, 2009.

(30) Foreign Application Priority Data
Jul. 28, 2008 (CN) 200810142580.2

(51) Int. Cl. H04L 9/00; G06F 11/07

(52) U.S. Cl. 714/48; 713/151; 714/E11.025

(57) ABSTRACT

A method and apparatus for processing packets are provided to extend the usage of a Cryptographically Generated Addresses (CGA) protocol. The method includes: receiving an Internet Protocol version 6 (IPv6) packet carrying CGA related information from a sender; obtaining the CGA related information from the IPv6 packet at the network layer, where the CGA related information includes the CGA parameters (CGA Params) and CGA signature (CGA Sig) of the sender; verifying the source address of the IPv6 packet according to the CGA Params and CGA Sig; transmitting the payload of the IPv6 packet after the verification succeeds. In the present invention, the packet is not limited to the IPv6 packet; the IP packet of a version later than IPv6 or the IP packet compatible with IPv6 may also be used.

### Cross-Reference to Related Applications

This application is a continuation of International Application No. PCT/CN2009/071733, filed on May 11, 2009, which claims priority to Chinese Patent Application No. 200810142580.2, filed on Jul. 28, 2008, both of which are hereby incorporated by reference in their entireties.

### FIELD OF THE INVENTION

The present invention relates to security technologies of computer networks, and in particular, to a method and apparatus for processing packets.

### BACKGROUND OF THE INVENTION

The Cryptographically Generated Addresses (CGA) protocol is defined in RFC 3972. A CGA is an Internet Protocol version 6 (IPv6) address. The address consists of 128 bits, where the first 64 bits are a subnet prefix and the last 64 bits are an interface identifier. The interface identifier of the CGA is generated by computing a one-way hash function according to a public key and some additional parameters. Re-computing the hash value and comparing the value with the interface identifier can verify the association between the address and the public key. Messages sent from the address are signed with a private key corresponding to the public key and the signature is verified by the receiver so that the source address is verified.

Although the CGA has the source address verification function, the CGA is mostly applied in one or several application protocols. The CGA is not universally applicable.

### SUMMARY OF THE INVENTION

Embodiments of the present invention provide a method and apparatus for processing packets, which can extend the usage of the CGA protocol.

A method for processing packets includes:
receiving an IP packet carrying CGA related information from a sender;
at the network layer, obtaining the CGA related information from the IP packet, where the CGA related information includes CGA parameters (CGA Params) and CGA signature (CGA Sig);
verifying a source address of the IP packet according to the CGA Params and CGA Sig; and
transmitting the payload of the IP packet to an upper layer of a protocol stack's network after the verification succeeds.

An apparatus for processing packets includes:
a receiving unit, configured to receive an IP packet carrying CGA related information from a sender;
an obtaining unit, configured to obtain the CGA related information from the IP packet at the network layer, where the CGA related information includes CGA parameters (CGA Params) and CGA signature (CGA Sig);
a verifying unit, configured to verify a source address of the IP packet according to the CGA Params and CGA Sig; and
a transmitting unit, configured to transmit the payload of the IP packet to an upper layer of a protocol stack's network after the verification succeeds.

In embodiments of the present invention, by adding the CGA Params and CGA Sig of the sender to the IP packet, the receiver can verify the source address of the IP packet at the network layer through the received information. In this way, security of the originally unreliable network layer is guaranteed. In addition, because the security mechanism is implemented at the network layer, the CGA may be applied more widely.

### BRIEF DESCRIPTION OF THE DRAWINGS

To illustrate the technical solution according to the embodiments of the present invention or in the prior art more clearly, the accompanying drawings for describing the embodiments or the prior art are given briefly below. Apparently, the accompanying drawings in the following description are only some embodiments of the present invention, and persons of ordinary skill in the art can derive other drawings from the accompanying drawings without creative efforts.

FIG. 1 shows a flowchart of a method for processing packets according to an embodiment of the present invention;

FIG. 2 shows a format of a CGA extension header according to an embodiment of the present invention;

FIG. 3 shows a format of a CGA Request option according to an embodiment of the present invention;

FIG. 4 shows a format of a CGA Params option according to an embodiment of the present invention;

FIG. 5 shows a format of a CGA Sig option according to an embodiment of the present invention;

FIG. 6 shows a flowchart of a method for processing packets according to another embodiment of the present invention;

FIG. 7 shows a flowchart of a verification procedure according to an embodiment of the present invention;

FIG. 8 shows an application scenario according to an embodiment of the present invention;

FIG. 9 shows a structure of an apparatus for processing packets according to an embodiment of the present invention;

FIG. 10 shows a structure of a requesting unit according to an embodiment of the present invention;

FIG. 11 shows another structure of a requesting unit according to an embodiment of the present invention; and

FIG. 12 shows a structure of a verifying unit according to an embodiment of the present invention.

### DETAILED DESCRIPTION OF THE EMBODIMENTS

The following detailed description is directed to the technical solution of the present invention with reference to the accompanying drawings. However, the embodiments to be described are only part of, rather than all of, the embodiments of the present invention. Additionally, all other embodiments, which can be derived by those skilled in the art from the embodiments given herein without any creative efforts, fall within the scope of the present invention.

In embodiments of the present invention, a CGA extension header is added to an IP packet such as the IPv6 header. The CGA extension header may include a CGA Request, CGA parameters (CGA Params), and a CGA signature (CGA Sig). The CGA extension header is used to carry the CGA related information. The packet receiver verifies the sender address according to the CGA related information. The following takes an IPv6 packet as an example. Other types of IP packets may also be applied in the present invention if the packets have fields for extending protocol headers or are compatible with IPv6 . For example, the IP packet of a version later than IPv6 or the IP packet compatible with IPv6 may be used in embodiments of the present invention if the IP packet has extension headers.

In IPv6, the optional network layer information is encoded in an independent header and placed between the IPv6 header and the upper-layer protocol header in the packet. An IPv6 header may carry zero, one, or multiple extension headers. Each extension header is identified by the Next Header field in the previous header. A CGA extension header may be added to the IPv6 header. For example, after a CGA extension header is added, the IPv6 header is arranged in the following sequence:

IPv6 header

0 Hop-by-Hop Options header
60 Destination Options header
43 Routing header

44 Fragment header
51 Authentication header

50 Encapsulating Security Payload header

60 Destination Options header

The number in front of each header is the protocol number and is assigned by the Internet Assigned Numbers Authority (IANA). The added CGA extension header may use a protocol number that is not assigned, for example, 149 in this example, or other protocol numbers that are not assigned.

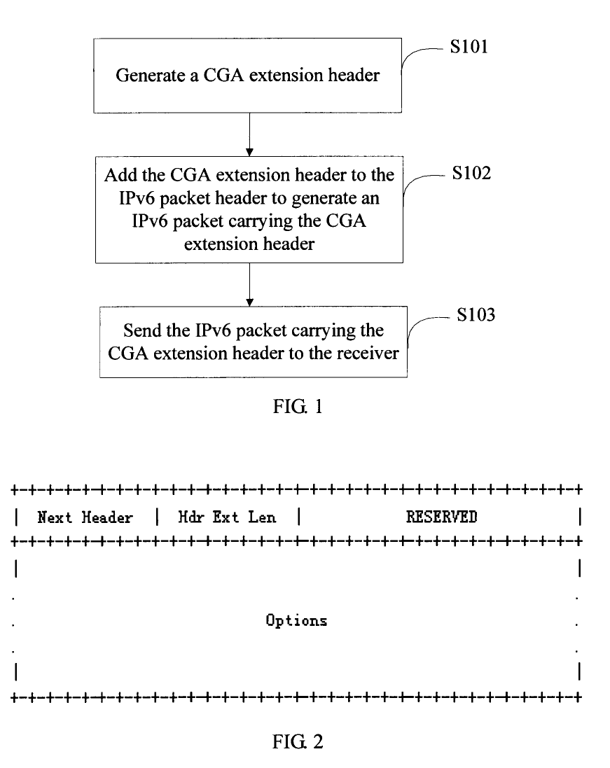

As shown in FIG. 1, in an embodiment of the present invention, when a sender sends an IPv6 packet carrying a CGA extension header, the method for processing the packet includes the following steps:

S101. Generate a CGA extension header.

The CGA extension header may include a public key and a digital signature of the sender. The sender generates an IPv6 source address by computing the one-way hash function according to the public key and some related parameters, attaches a digital signature by using the private key of the sender, and pads the related parameters and digital signature in the corresponding positions of the CGA extension header.

S102. Add the CGA extension header to the IPv6 packet to generate an IPv6 packet carrying the CGA extension header.

The CGA extension header is located between the IPv6 header and the upper-layer protocol header in the IPv6 packet.

S103. Send the IPv6 packet carrying the CGA extension header to the receiver, where the IPv6 packet is used for the receiver to verify the source address of the IPv6 packet sender.

The format of a CGA extension header in an embodiment of the present invention is shown in FIG. 2. The CGA extension header includes the following fields: Next Header, Hdr Ext Len, Reserved, and Options.

The Next Header field is an 8-bit selector and identifies the type of the next header in the CGA extension header.

The Hdr Ext Len field is an 8-bit unsigned integer. This field identifies the length of the CGA extension header measured in 8 bytes. The first 8 bytes are excluded during length calculation. The length of this field is 0, indicating a special meaning, namely, initializing the CGA. When one communication party wants to use the CGA to protect the communication, a CGA extension header with the length 0 may be sent; when the communication party receives the extension header with the length 0, the party sends a CGA Request to the peer.

The 16-bit Reserved field is used for future extension. This field is set to 0.

The Options field with a variable length includes one or multiple data types.

Three types of data may be selected for the Options field: CGA Request, CGA Params, and CGA Sig. The CGA Request option is used to request the peer to provide CGA parameters; the CGA Params option is used to transmit CGA parameters; and the CGA Sig option indicates the signature attached to the payload of a packet by using the private key of a CGA node. If the CGA extension header includes a CGA Params option, the CGA extension header also includes a CGA Sig option; otherwise, the receiver sends an Internet Control Message Protocol (ICMP) error message to the source address of the sender, notifying the unidentifiable option type. When no CGA Request is received, the sender may also add a CGA extension header to the packet; the processing mode (authenticate or ignore) of the CGA extension header is decided by the receiver.

At the network layer, the sender host receives the packet from the upper layer. The CGA extension header may be encapsulated during the encapsulation of the IPv6 header. If the header of the packet sent by the host includes a CGA Request option, the source address of the receiver needs to be verified. The packet returned by the receiver needs to carry the CGA Params and CGA Sig options, providing data contents required by the sender host for verification. The value of the Sequence Number field in the CGA Params option is the value of the Sequence Number field in the CGA Request option plus 1. The sender host may also actively add a CGA extension header to the sent packet, including the CGA Params and CGA Sig options to provide related data contents for the receiver to verify the sender address, where the Sequence Number field in the CGA Params option is set to 0.

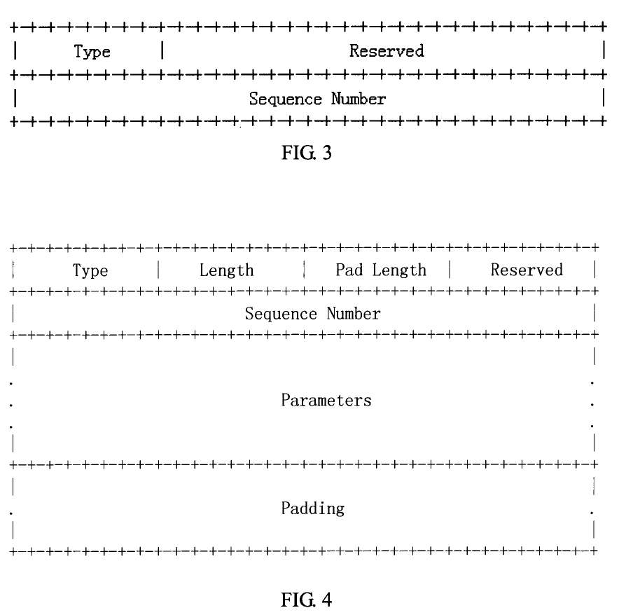

The format of a CGA Request option in an embodiment of the present invention is shown in FIG. 3. The CGA Request option includes the following fields: Type, Reserved, and Sequence Number.

The Type field is an 8-bit unsigned integer. In this embodiment, when the Type field is set to 193,it indicates that the packet carries a CGA Request option. In other embodiments, other values may also be used to indicate that the packet carries a CGA Request option.

The 24-bit Reserved field is used for future extension. This field is set to 0.

The Sequence Number field is a 32-bit random number, including information for preventing replay attacks.

The host may actively initiate a CGA Request to the receiver according to the upper-layer protocol, requesting the receiver to send the CGA Params and CGA Sig information for verifying the source address of the receiver.

The format of a CGA Params option in an embodiment of the present invention is shown in FIG. 4. The CGA Params option includes the following fields: Type, Length, Pad Length, Reserved, Sequence Number, Parameters, and Padding.

The Type field is an 8-bit unsigned integer. In this embodiment, when the Type field is set to 194, it indicates the packet carries a CGA Params option. In other embodiments, other values may also be used to indicate that the packet carries a CGA Params option.

The Length field is an 8-bit unsigned integer measured in 8 bytes, indicating the length of the entire CGA Params, namely, the sum of lengths of the fields such as Type, Length, Pad Length, Reserved, Sequence Number, Parameters, and Padding.

The Pad Length field is an 8-bit unsigned integer measured in bytes, indicating the length of the Padding field.

The 8-bit Reserved field is used for future extension. This field must be set to 0.

The Sequence Number field is a 32-bit integer, including information for preventing replay attacks. If the CGA Params option is used for responding to the CGA Request, the value of the Sequence Number field is the value of the Sequence Number field in the CGA Request option plus 1; otherwise, this field is set to 0.

The Parameters field with a variable length includes the CGA Params information.

The Padding field with a variable length is used to make the packet length a multiple of 8 bytes. The content of the Padding field is 0.

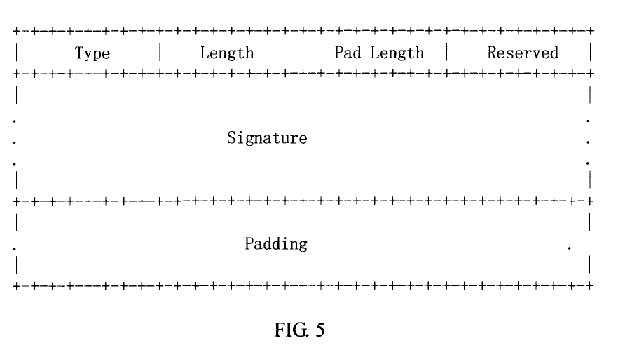

The format of a CGA Sig option in an embodiment of the present invention is shown in FIG. 5. The CGA Sig option includes the following fields: Type, Length, Pad Length, Reserved, Signature, and Padding.

The Type field is an 8-bit unsigned integer. In this embodiment, when the Type field is set to 195, it indicates the packet carries a CGA Sig option. In other embodiments, other values may also be used to indicate that the packet carries a CGA Sig option.

The Length field is an 8-bit unsigned integer measured in 8 bytes, indicating the length of the entire CGA Sig, namely, the sum of lengths of the fields such as Type, Length, Pad Length, Reserved, Signature, and Padding.

The Pad Length field is an 8-bit unsigned integer measured in bytes, indicating the length of the Padding field.

The 8-bit Reserved field is used for future extension. This field is set to 0.

The Signature field with a variable length includes the signature attached to the packet content by using the private key of the sender.

The Padding field with a variable length is used to make the packet length a multiple of 8 bytes. The content of the Padding field is 0.

After receiving the CGA Request from the sender, the receiver returns a packet carrying the CGA Params and CGA Sig options to the sender, providing data contents required by the sender host for verification. In this way, the value of the Sequence Number field in the CGA Params option is the value of the Sequence Number field in the CGA Request option plus 1. The sender may also actively add a CGA extension header to the sent packet, including the CGA Params and CGA Sig options to provide related data contents for the receiver to verify the sender address, where the Sequence Number field in the CGA Params option is set to 0.

The CGA Params field carried in the CGA Params option corresponds to the source address in the IPv6 packet header. The sender generates an IPv6 source address by computing a one-way hash function according to the public key and some additional parameters, and generates other parameters according to the CGA protocol requirement.

The private key used for the signature in the CGA Sig option corresponds to the public key carried in the CGA Params option of the same extension header.

The step in which the sender generates a CGA Sig option is as follows:

The host obtains the following contents and connects the contents in sequence:

128-bit source address obtained from the header information of the IP packet;

128-bit destination address obtained from the header information of the IP packet;
CGA extension header except the CGA Sig option; and
payload of the IP packet (at the transport layer and higher layers).

The host uses a private key to sign the obtained data and places the signature in the Signature field in the CGA Sig option.

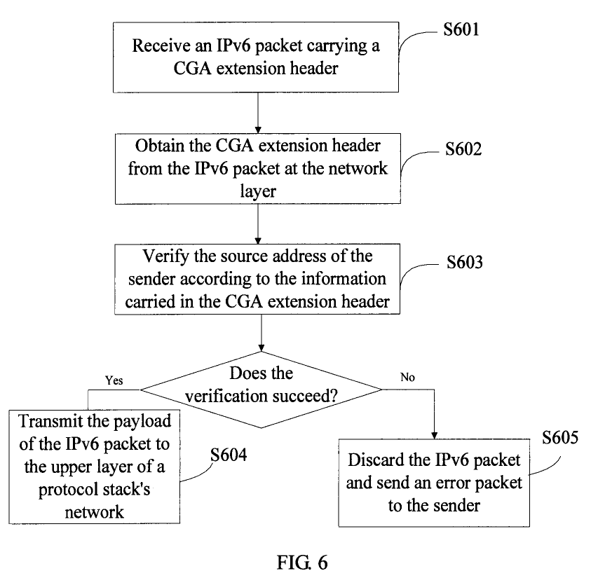

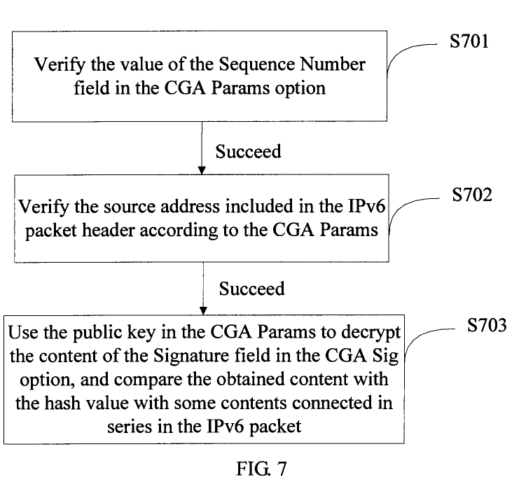

As shown in FIG. 6, in an embodiment of the present invention, when the receiver receives an IPv6 packet carrying a CGA extension header, the processing procedure is as follows:

S601. The receiver receives an IPv6 packet carrying a CGA extension header from the sender.

The network layer of the receiver receives the IPv6 packet transmitted from the lower layer.

S602. At the network layer, the receiver obtains the CGA extension header from the IPv6 packet, where the CGA extension header includes the CGA Params and CGA Sig of the sender.

S603. The receiver verifies the source address of the sender according to the information carried in the CGA extension header.

The receiver verifies the IPv6 packet according to the information in the CGA Params option and the information in the CGA Sig option carried in the CGA extension header.

S604. If the verification succeeds, the receiver transmits the payload of the IPv6 packet to the upper layer, which processes the packet.

S605. If the verification fails, the receiver discards the IPv6 packet and sends an ICMP error packet to the sender.

Before step S603, the procedure may further include: The network layer confirms whether verification of the source address of the IPv6 packet is required; the network layer may determine whether to perform verification according to related configuration information. The configuration information usually comes from the upper-layer protocol. The upper-layer protocol may generate the configuration information according to the user input, default configuration of the host, or security requirements of the upper-layer protocol, and notify the configuration information to the network layer. If the receiver confirms according to the related configuration information whether a verification is required, an embodiment of the verification procedure is as follows:

S701. The receiver verifies the value of the Sequence Number field in the CGA Params option.

If the received IPv6 packet is a response to the CGA Request, the receiver first deducts 1 from the sequence number in the CGA Params option and compares the result with the sequence number in the CGA Request cached by the receiver. If the contents are consistent, the receiver performs step S702; otherwise, the receiver discards the IPv6 packet and sends an ICMP error packet.

S702. According to the parameter information in the CGA Params option, the receiver verifies the source address included in the IPv6 packet header. If the verification succeeds, the receiver performs step S703; otherwise, the receiver discards the IPv6 packet and sends an ICMP error packet.

S703. The receiver uses the public key in the CGA Params to decrypt the content of the Signature field in the CGA Sig option, and compares the obtained content with the hash value with some contents connected in series in the IPv6 packet. If the contents are consistent, the verification succeeds; otherwise, the receiver discards the IPv6 packet and sends an ICMP error packet.

Before step S601, the procedure may further include:

The receiver generates and sends an IPv6 packet carrying a CGA extension header to the sender, where the CGA extension header includes a CGA Request option, requesting the sender to send the CGA related information.

The sender returns an IPv6 packet carrying the CGA extension header, which includes the CGA Params and CGA Sig options. The value of the Sequence Number field in the CGA Params option is the value of the Sequence Number field in the CGA Request option plus 1.

The step in which the receiver generates and sends an IPv6 packet carrying a CGA extension header includes:

The receiver generates a CGA extension header, which includes the CGA Request option.

The receiver adds the CGA extension header to the IPv6 packet to generate an IPv6 packet carrying the CGA extension header.

The receiver sends the IPv6 packet carrying the CGA extension header to the sender.

In the method for processing packets in another embodiment of the present invention, the sender uses the existing Destination Options header to carry the CGA related information for replacing the newly created CGA extension header, thus implementing the related functions of the CGA.

When the value of the Next Header field in the header is 60, it indicates the next header is a Destination Options header. The existing Destination Options header includes the following fields: Next Header, Hdr Ext Len, and Options.

The Next Header is an 8-bit selector and identifies the type of the next header in the Destination Options header.

The Hdr Ext Len field is an 8-bit unsigned integer. This field identifies the length of the Destination Options header measured in 8 bytes. The first 8 bytes are excluded during length calculation.

The Options field with a variable length includes one or multiple data types.

In embodiments of the present invention, the Destination Options header carries the CGA related information, which corresponds to the three data types of the Options field in the preceding CGA extension header: namely, CGA Request, CGA Params, and CGA Sig. In embodiments of the present invention, the three data types may be directly added to the Options field in the Destination Options header. In this way, a new CGA extension header is not required.

In the existing IPv6 header, the Destination Options header may be present once or at most twice. Embodiments of the present invention are not restricted by the times of presence of the Destination Options header. Any Destination Options header may carry the CGA related information, or any two Destination Options headers may carry the CGA related information.

In this embodiment, the method for the sender and the receiver to process the CGA related information is basically the same as that in the previous embodiment. The difference is that: In this embodiment, the sender adds the Destination Options header carrying the CGA related information to the packet, and the receiver extracts the CGA related information from the Destination Options header for verification; in the previous embodiment, the sender uses a new CGA extension header, and the receiver extracts the content information from the new CGA extension header for verification.

In the method for processing packets in embodiments of the present invention, by adding the CGA related information such as CGA Params and CGA Sig to the IPv6 packet, the receiver may use the received information to verify the source address of the IPv6 packet at the network layer, providing a method for the network layer to verify the source address and giving full play to the CGA protocol in source address verification; in this way, security of the originally unreliable network layer is guaranteed. In addition, because security verification is performed at the network layer, the security mechanism is not limited to one or several upper-layer application protocols, and is universally applicable.

The packet in the present invention is not limited to the IPv6 packet. For example, the IP packet of a version later than IPv6 or the IP packet compatible with IPv6 may be used in embodiments of the present invention if the IP packet has extension headers. The procedure is similar to the procedure in the preceding embodiments.

Persons of ordinary skill in the art should understand that all or part of the steps of the method according to the embodiments of the present invention may be implemented by a program instructing relevant hardware. The program may be stored in a computer readable storage medium. When the program runs, the steps of the method according to the embodiments of the present invention are performed. The storage medium may be a magnetic disk, a compact disk read-only memory (CD-ROM), a read-only memory (ROM) or a random access memory (RAM).

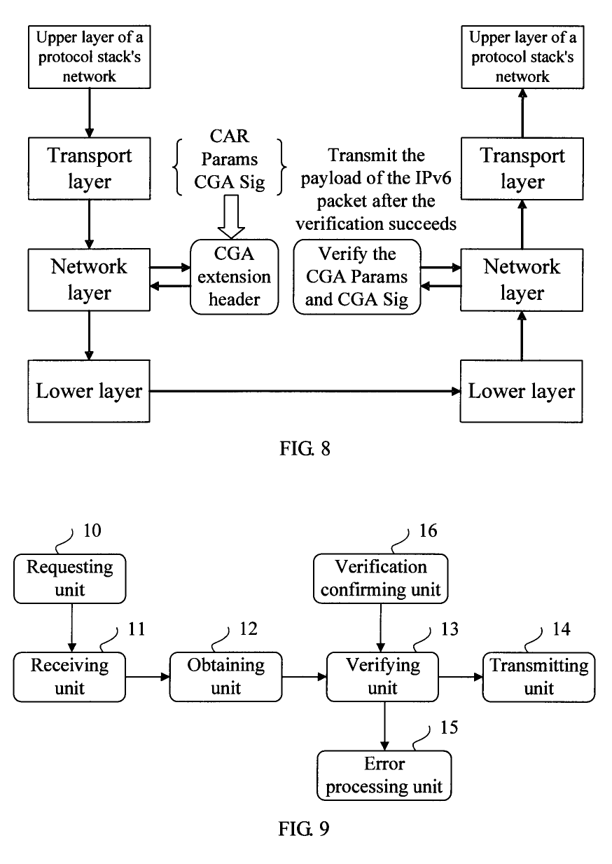

FIG. 8 shows an application scenario of an embodiment of the present invention. For two hosts in communications, the sender adds the CGA Params and CGA Sig to the CGA extension header at the network layer and encapsulates the CGA extension header to the IPv6 packet, and then sends the IPv6 packet out; the receiver extracts the CGA Params and CGA Sig of the sender at the network layer and performs verification; if the verification succeeds, the receiver transmits the payload of the IPv6 packet to the transport layer.

The sender may also directly add the CGA Params and CGA Sig to the existing Destination Options header at the network layer and encapsulate the Destination Options header to the IPv6 packet, and then send the IPv6 packet out; the receiver extracts the CGA Params and CGA Sig of the sender at the network layer and performs verification; if the verification succeeds, the receiver transmits the payload of the IPv6 packet to the transport layer.

As shown in FIG. 9, an apparatus for processing packets in an embodiment of the present invention includes:
a receiving unit 11, configured to receive an IPv6 packet carrying CGA related information from a sender;
an obtaining unit 12, configured to obtain the CGA related information from the IPv6 packet at the network layer, where the CGA related information includes CGA Params and CGA Sig;
a verifying unit 13, configured to verify the source address of the IPv6 packet according to the CGA Params and CGA Sig; and
a transmitting unit 14, configured to transmit the payload of the IP packet to an upper layer of a protocol stack's network after the verification succeeds.

The apparatus for processing packets in an embodiment of the present invention may further include:
an error processing unit 15, configured to discard the IPv6 packet when the verification fails and send an error packet to the sender.

The apparatus for processing packets in an embodiment of the present invention may further include:
a requesting unit 10, configured to send an IPv6 packet carrying a CGA Request, requesting the sender to send the CGA related information that is to be received by the receiving unit 11.

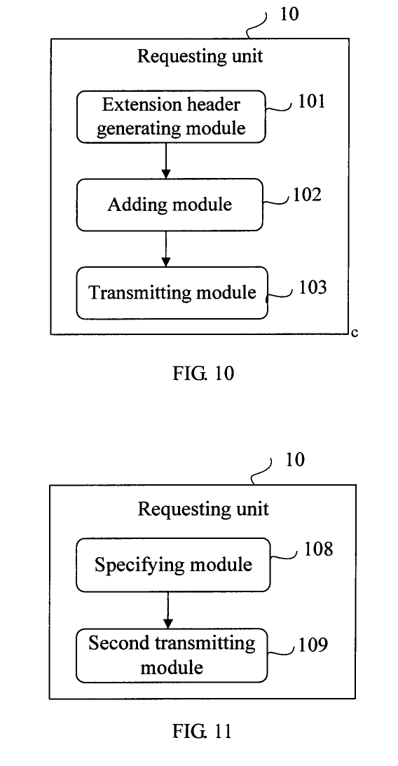

As shown in FIG. 10, the requesting unit 10 in an embodiment of the present invention may include:
an extension header generating module 101, configured to generate a CGA extension header, where the CGA extension header includes a CGA Request option;
an adding module 102, configured to add the CGA extension header to the IPv6 packet to generate an IPv6 packet carrying the CGA extension header; and
a sending module 103, configured to send the IPv6 packet carrying the CGA extension header to the sender, requesting the sender to add the CGA related information to the CGA extension header.

As shown in FIG. 11, the requesting unit 10 in another embodiment of the present invention may include:
a specifying module 108, configured to specify the Destination Options header in the IP packet, where the specified Destination Options header includes a CGA Request option; and
a second sending module 109, configured to send the IP packet carrying the Destination Options header to the sender, requesting the sender to add the CGA related information to the Destination Options header.

As shown in FIG. 9, the apparatus for processing packets in an embodiment of the present invention may further include:
a verification confirming unit 16, configured to confirm according to the related configuration information whether verification of the source address of the IPv6 packet is required.

The configuration information usually comes from the upper-layer protocol. The upper-layer protocol may generate the configuration information according to the user input, default configuration of the host, or security requirements of the upper-layer protocol, and notify the configuration information to the network layer.

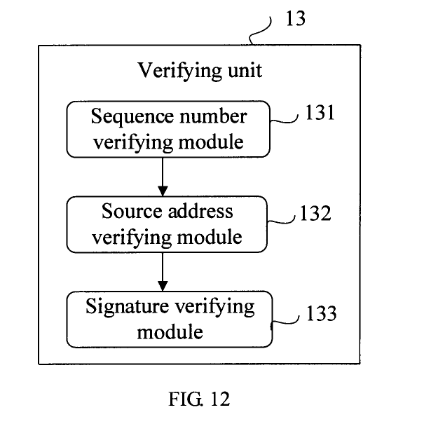

As shown in FIG. 12, the verifying unit 13 in an embodiment of the present invention includes:
a sequence number verifying module 131, configured to: verify the value of the Sequence Number field in the CGA Params option, and transmit the IPv6 packet to a source address verifying module 132 after the verification succeeds, or output a verification result of failure after the verification fails;
the source address verifying module 132, configured to: verify the source address included in the IPv6 packet header according to the parameters in the CGA Params option, and transmit the IPv6 packet to a signature verifying module 133 after the verification succeeds, or output a verification result of failure after the verification fails; and
the signature verifying module 133, configured to: use the public key in the CGA Params option to decrypt the content of the Signature field in the CGA Sig option, compare the obtained content with the hash value with some contents connected in series in the IPv6 packet, and if the contents are consistent, output a verification result indicating the verification succeeds, or else, output a verification result indicating the verification fails.

In embodiments of the present invention, by adding the CGA related information such as CGA Params and CGA Sig to the IPv6 packet, the receiver may use the received information to verify the source address of the IPv6 packet at the network layer, providing a method for the network layer to verify the source address and giving full play to the CGA protocol in source address verification; in this way, security of the originally unreliable network layer is guaranteed. In addition, because security verification is performed at the network layer, the security mechanism is not limited to one or several upper-layer application protocols and is universally applicable.

The packet processed by the apparatus of the present invention is not limited to the IPv6 packet. For example, the IP packet of a version later than IPv6 or the IP packet compatible with IPv6 may be used in embodiments of the present invention if the IP packet has extension headers. The implementation is similar to that of the apparatus in the preceding embodiments.

Those skilled in the art may be aware that in combination with the units and algorithm steps disclosed in embodiments of the present invention, the present invention may be implemented by electronic hardware or/and computer software. To clarify the interchangeability between hardware and software, the composition and steps of each embodiment have been described according to the functions. Whether these functions are executed through hardware or software depends on the specific applications and design constraints of the technical solution. Those skilled in the art may use different methods to implement the described functions according to each specific application, but the implementation shall fall within the scope of the present invention.

In combination with the method and algorithm steps disclosed in embodiments of the present invention, the present invention may be implemented by hardware or/and a software module executed by a processor. The software module may be stored in a random-access memory (RAM), a memory, a read-only memory (ROM), an electrically-programmable read-only memory (EPROM), an electrically-erasable programmable read-only memory (EEPROM), a register, a hard disk, a removable disk, a CD-ROM, or a storage medium of any form.

Detailed above are only exemplary embodiments of the present invention. It is apparent that those skilled in the art can make various modifications and variations to the present invention without departing from the spirit and scope of the present invention.

What is claimed is:

1. A method for processing packets, comprising:
receiving an Internet Protocol (IP) packet carrying Cryptographically Generated Addresses (CGA) related information from a sender;
at a network layer, obtaining the CGA related information from the IP packet, wherein the CGA related information comprises CGA parameters (CGA Params) and CGA signature (CGA Sig);
verifying a source address of the IP packet according to the CGA Params and CGA Sig; and
transmitting a payload of the IP packet to an upper layer of a protocol stack's network after the verification succeeds.

2. The method of claim 1, further comprising:
discarding the IP packet when the verification fails and sending an error packet to the sender.

3. The method of claim 1, wherein the step of verifying the source address of the IP packet according to the CGA Params and CGA Sig comprises:
verifying the value of a Sequence Number field in a CGA Params option;
verifying the source address comprised in an IP packet header according to parameters in the CGA Params option if the verification succeeds; and
using a public key in the CGA Params option to decrypt a content of a Signature field in a CGA Sig option after the verification succeeds, comparing the obtained content with a hash value with some contents connected in series in the IP packet, and if the contents are consistent, outputting a verification result indicating the verification succeeds.

4. The method of claim 1, wherein before the step of receiving the IP packet carrying the CGA related information from the sender, further comprising:
sending an IP packet carrying a CGA Request to the sender for requesting the sender to send CGA related information.

5. The method of claim 4, wherein the step of sending the IP packet carrying the CGA Request to the sender for requesting the sender to send the CGA related information comprises:
generating a CGA extension header, which comprises a CGA Request option;
adding the CGA extension header to the IP packet to generate an IP packet carrying the CGA extension header; and
sending the IP packet carrying the CGA extension header to the sender for requesting the sender to add the CGA related information to the CGA extension header.

6. The method of claim 4, wherein the step of sending the IP packet carrying the CGA Request to the sender for requesting the sender to send the CGA related information comprises:
specifying a Destination Options header in the IP packet, wherein the specified Destination Options header comprises a CGA Request option; and
sending the IP packet carrying the Destination Options header to the sender for requesting the sender to add the CGA related information to the Destination Options header.

7. The method of claim 1, wherein, before the step of verifying the source address of the IP packet according to the CGA Params and CGA Sig, the method comprises:
confirming, by the network layer, whether verification on the source address of the IP packet is required according to related configuration information.

8. The method claim 1 wherein the IP packet is an Internet Protocol version 6 (IPv6 ) packet.

9. An apparatus for processing packets, comprising:
a receiving unit, configured to receive an Internet Protocol (IP) packet carrying Cryptographically Generated Addresses (CGA) related information from a sender;
an obtaining unit, configured to obtain the CGA related information from the IP packet at a network layer, wherein the CGA related information comprises CGA parameters (CGA Params) and CGA signature (CGA Sig) of the sender;
a verifying unit, configured to verify a source address of the IP packet according to the CGA Params and CGA Sig; and
a transmitting unit, configured to transmit a payload of the IP packet to an upper layer of a protocol stack's network after the verification succeeds.

10. The apparatus of claim 9, further comprising:
an error processing unit, configured to discard the IP packet when the verification fails and send an error packet to the sender.

11. The apparatus of claim 9, wherein the verifying unit comprises:
a sequence number verifying module, configured to: verify the value of a Sequence Number field in a CGA Params option, and transmit the IP packet to a source address verifying module after the verification succeeds;
the source address verifying module, configured to: verify a source address comprised in an IP packet header according to parameters in the CGA Params option, and transmit the IP packet to a signature verifying module after the verification succeeds; and
the signature verifying module, configured to: use a public key in the CGA Params option to decrypt a content of a Signature field in a CGA Sig option, compare the obtained content with a hash value with some contents connected in series in the IP packet, and if the contents are consistent, output a verification result indicating the verification succeeds.

12. The apparatus of claim 10, wherein the verifying unit comprises:
a sequence number verifying module, configured to: verify the value of a Sequence Number field in a CGA Params option, and transmit the IP packet to a source address verifying module after the verification succeeds;
the source address verifying module, configured to: verify a source address comprised in an IP packet header according to parameters in the CGA Params option, and transmit the IP packet to a signature verifying module after the verification succeeds; and
the signature verifying module, configured to: use a public key in the CGA Params option to decrypt a content of a Signature field in a CGA Sig option, compare the obtained content with a hash value with some contents connected in series in the IP packet, and if the contents are consistent, output a verification result indicating the verification succeeds.

13. The apparatus of claim 9, further comprising:
a requesting unit, configured to send an IP packet carrying a CGA Request to the sender for requesting the sender to send CGA related information.

14. The apparatus of claim 13, wherein the requesting unit comprises:
an extension header generating module, configured to generate a CGA extension header, wherein the CGA extension header comprises a CGA Request option;
an adding module, configured to add the CGA extension header to the IP packet to generate an IP packet carrying the CGA extension header; and
a sending module, configured to send the IP packet carrying the CGA extension header to the sender, requesting the sender to add the CGA related information to the CGA extension header.

15. The apparatus of claim 13, wherein the requesting unit comprises:
a specifying module, configured to specify a Destination Options header in the IP packet, wherein the specified Destination Options header comprises a CGA Request option; and
a second sending module, configured to send the IP packet carrying the Destination Options header to the sender, requesting the sender to add the CGA related information to the Destination Options header.

16. The apparatus of claim 9, further comprising:
a verification confirming unit, configured to: confirm according to related configuration information whether verification on a source address of an Internet Protocol version 6 (IPv6 ) packet, is required and trigger the verifying unit to verify the source address of the IPv6 packet.

17. The apparatus of claim 10, further comprising:
a verification confirming unit, configured to: confirm according to related configuration information whether verification on a source address of an Internet Protocol version 6 (IPv6 ) packet, is required and trigger the verifying unit to verify the source address of the IPv6 packet.
